(19) United States
(12) Patent Application Publication
(10) Pub. No.: US 2003/0089258 A1
(43) Pub. Date: May 15, 2003

(54) Pocket stamp

(76) Inventor: Michael Rigoni, Niedereschach-Fischbach (DE)

Correspondence Address: Stephan A. Pendorf, Pendorf & Cutliff, P.O. Box 20445, Tampa, FL, 33622-0445, US

(21) Appl. No.: 10/292,746

(22) Filed: Nov. 12, 2002

(30) Foreign Application Priority Data
Nov. 9, 2001 (DE) 201 18 278.5

(51) Int. Cl. B41K 1/56

(52) U.S. Cl. 101/405

(57) ABSTRACT

A pocket stamp, comprised of a container in which a stamp is provided and a lid mounted pivotably on the container. In the closed position the lid covers the stamp face and in the open position serves as a handle. The container comprises a shell shaped lower part (20) and the lid comprises a shell shaped upper part (10) of a flat container. The lower part (20) and upper part (10) are pivotably connected with each other via a hinge element (28, 18). This simple design makes possible the provision of a container with less than 3 mm thickness, so that a pocket stamp of this type can easily be mailed in a conventional envelope or be slipped by the user into his pocketbook or briefcase. Besides this, the upper and lower parts, in particular when they are connected to each other via a film hinge or living hinge, can be manufactured in one piece by injection molding, whereby the manufacturing costs can be substantially reduced.

### BACKGROUND OF THE INVENTION

1. Field of the Invention

The invention concerns a pocket stamp, which is comprised of a container, in which a stamp is provided and upon which a lid is pivotably mounted, which in the closed position covers the face of the stamp and in the open position functions as a handle.

2. Description of the Related Art

Pocket stamps, in which a stamp and a stamp pad are provided in a common container, are known for example from EP 364 072 A2.

It is a disadvantage of this design, that the stamp must be removed from the container in order to stamp. Further the construction of this stamp as comparatively voluminous and, beyond this, complicated, which increases the cost of manufacture.

A pocket stamp of this general type is known from DE 23 32 501. This stamp employs an ink-impregnated material. The print face of the stamp can be covered over by means of a lid mounted pivotably on a container, wherein the lid in the open position functions as a handle.

This pocket stamp does not have components which could be lost, but is however likewise complicated in construction and voluminous in structure.

### SUMMARY OF THE INVENTION

The present invention is concerned with the task of providing a pocket stamp of the above described type, which is small and flat as well as robust, easy to operate and can be manufactured with low cost.

This task is solved thereby, that the stamp containing container as well as the lid are shell-shaped lower and upper sides of a flat container, wherein the lower part and upper part are elastically connected with each other via a one-part or unitary hinge element.

This extraordinarily simple design makes possible the provision of a container with less than 3 mm thickness, so that a pocket stamp of this type can easily be mailed in a conventional envelope or be slipped by the user into his pocketbook or briefcase.

Besides this, the upper and lower parts, in particular when they are connected to each other via a film hinge or living hinge, can be manufactured in one piece by injection molding, whereby the manufacturing costs can be substantially reduced.

The upper part of the container functions as a handle in the opened condition, thus as a grip.

In order to make possible a reliable operation of this stamp, it is proposed, that the upper part is pivotable relative to the lower part by more than 180°, preferably 270°, whereby the upper and lower part can be arrested or detained when in the pivoted position relative to each other.

For the purpose of locking, spring biased detent elements are provided on the upper and lower part in the area of the hinge, which engage with each other when the upper part is in the pivoted position.

In order to simplify the operation of the upper and lower parts and to prevent the user staining himself with stamp ink, in accordance with a further characteristic of the invention the upper and lower parts are provided with grip bars projecting sideways out from the contour of the container.

Preferably, the grip bars of the upper and lower parts are set off relative to each other by 90°. Preferably, the oppositely lying sides of the lower part are respectively provided with one grip piece and the perpendicular to this side running side of the upper part is provided with a further grip part that is set off by 90° relative to the first grip part.

For a pocket stamp of the inventive type it is further important, that upper and lower parts are securely locked to each other during transport and storage. On the one hand, thereby an undesired opening of the stamp is to be avoided, and on the other hand, a drying out of the stamp or as the case may be ink pad is to be prevented thereby, or at least delayed.

For this purpose upper and lower parts must be capable of being locked. For this locking, it is proposed to provide on the side opposite to the hinge, and associated with the upper and lower part respectively, a lock part and a lock nose part adapted for engaging each other. For aesthetic purposes it is preferred when these lock and lock nose parts are provided in the area of the grip piece of the upper part, so that in the closed condition this covered over.

All known stamp systems are suitable for the inventive pocket stamp.

Thus for example there can be employed as lower part an ink-impregnated stamp, preferably a micro-sponge stamp.

Likewise in conventional manner a rubber or rubber-like synthetic stamp can be provided in the lower part, wherein a complimentary stamp pad can be provided in the upper part, so that the stamp pad in the closed condition of the container lies flush against the upper face of the stamp and colors this.

On the basis of the flat design, the inventive pocket stamp is extraordinarily useful as advertising or sample material. Thus, the outer surface of the upper or lower part could be planar to serve as surface for advertising.

### BRIEF DESCRIPTION OF THE DRAWING

The subject of the invention is described in greater detail in the following on the basis of a preferred embodiment, which is shown in the drawings.

In the drawings there is shown:

FIG. 1 perspective representation of the inventive pocket stamp in closed condition,

FIG. 2 front view of the pocket stamp according to FIG. 1,

FIG. 3 rear view of the inventive stamp with upper and lower part pivoted by 180° relative to each other,

FIG. 4 top view of the opened pocket stamp according to FIG. 3,

FIG. 5 rear view of the opened pocket stamp in the stamping position, in which the upper part is pivoted by 270° relative to the lower part,

FIG. 6 enlarged partial section according to line A-A with slightly opened position of the container,

FIG. 7 section according to FIG. 6 in closed condition of the container,

FIG. 8 enlarged detailed B of FIG. 3 and

FIG. 9 section along line C-C in FIG. 8 in the opened end-position of the container.

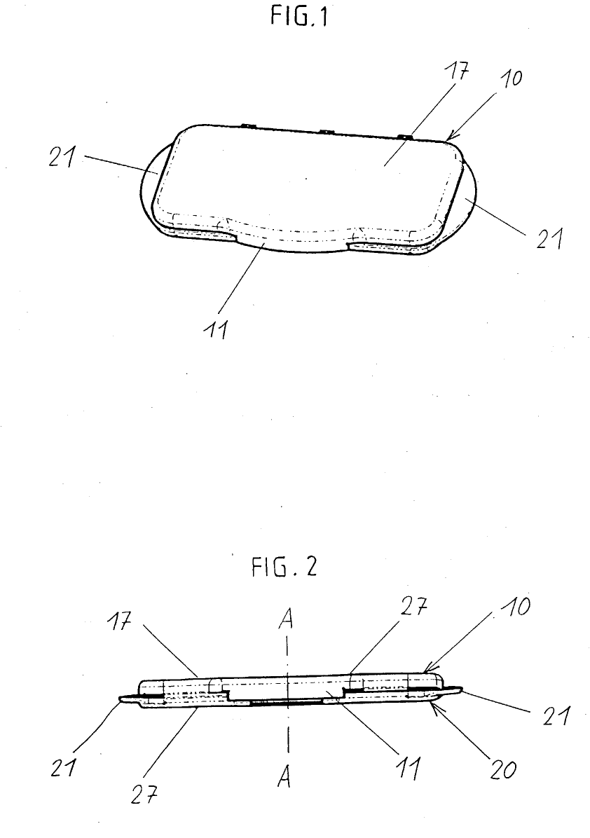

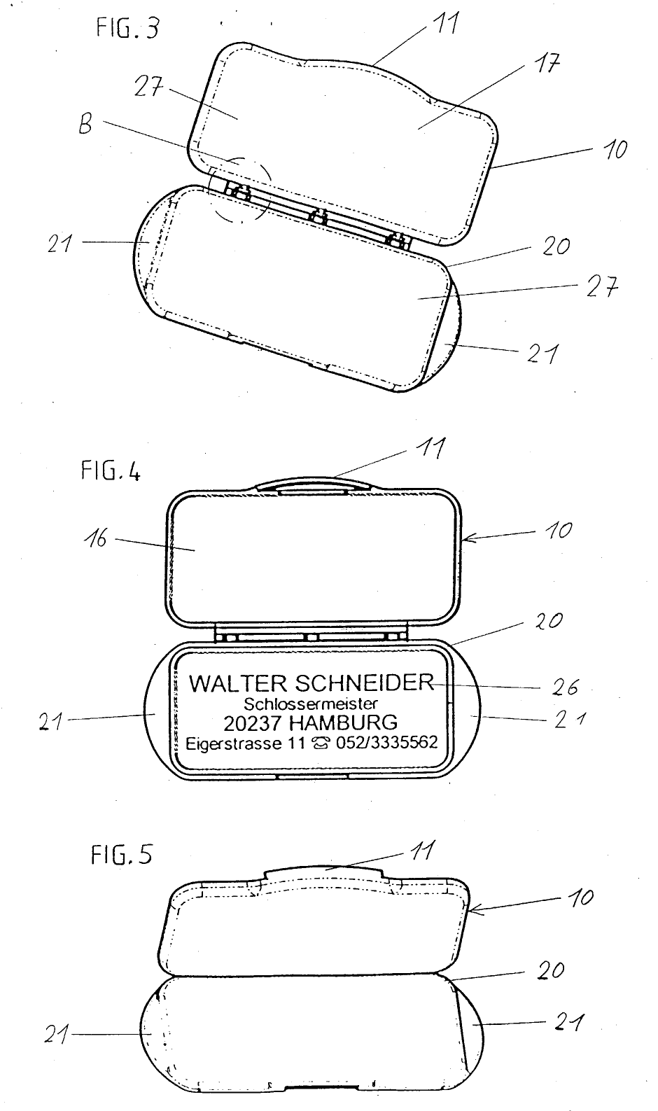

### DETAILED DESCRIPTION OF THE INVENTION

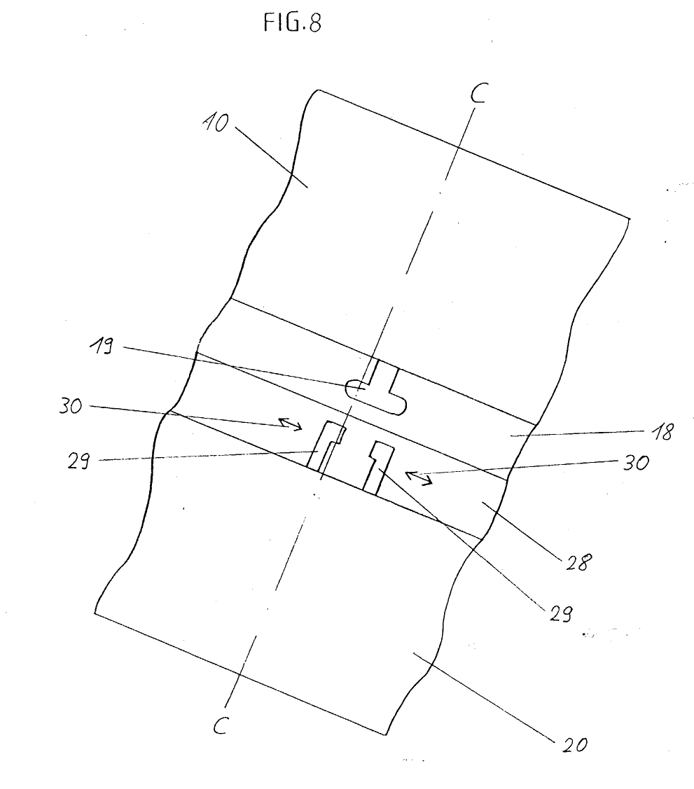

The inventive pocket stamp includes upper and lower parts 10 and 20, which are pivotably connected with each other via one piece hinge halves 18 and 28 (see FIG. 8).

In the here shown embodiment a flat stamp 26 is provided in the lower part 20 and an ink pad 16 is provided in the upper part of this stamp.

The stamp pad could be dispensed with, when the stamp is an ink impregnated micro-sponge material or a pre-impregnated, so-called “3-S” stamp (three-step-stamp) similar to that described in U.S. Pat. No. 5,611,279.

On the shell-shaped upper part 10 and lower part 20 there are provided grip bars 11 and 21 projecting sideways beyond the contour of the container. Since the grip bar 11 of the upper part 10 is set off or displaced by 90° relative to the grip bar pair 21 of the lower part 20, the container can be opened manually in simple manner, without the fingers of the user becoming stained with ink. The outer surface 17 and 27 of the upper and lower parts 10, 20 of this very flat container are planar, so that they can be easily imprinted, and therewith the pocket stamp is particularly suitable as carrier for advertising.

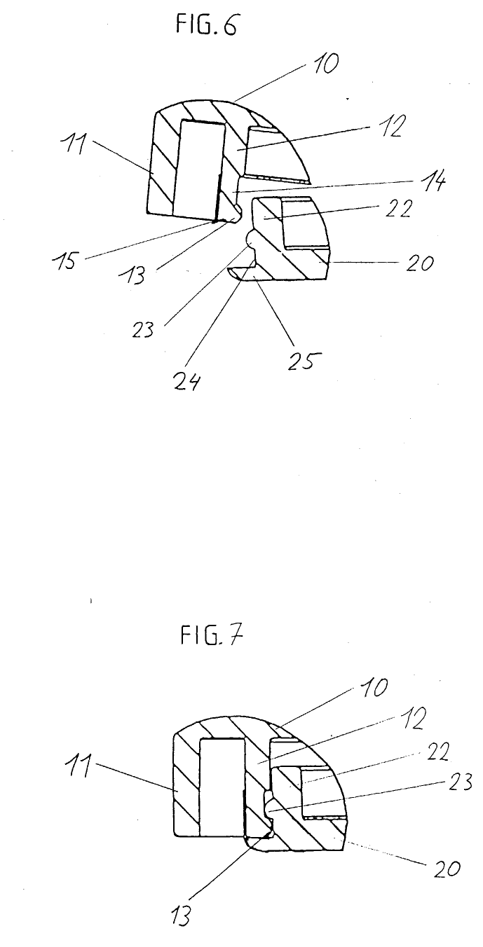

In FIGS. 6 and 7 a very reliable and simple to manufacture means for locking of the upper and lower part 10 and 20 can be seen.

For this purpose a lock nose 13 and lock piece 14 are provided on a vertical lock cross-piece 12 in the area of the grip bar 11. This associates with a lock nose 23 and the lock 24, which are part of the vertical cross-piece 22 of the lower part 20.

In the closed condition, which can be seen in FIG. 7, the lock nose 13 of the upper part 10 engages in the lock 24 of the lower part 20 and the lock nose 23 of the upper part 20 engages in the lock 14 of the upper part 10. For further security, a lower covering 25 of the lower part 20 lies against a lower detent surface 15 of the upper part 10. With these locking elements the upper part 10, 20 are connected tightly but releasably with each other, whereby simultaneously a nearly airtight closure is made possible, which substantially prevents a drying out of the stamp or as the case may be ink pad.

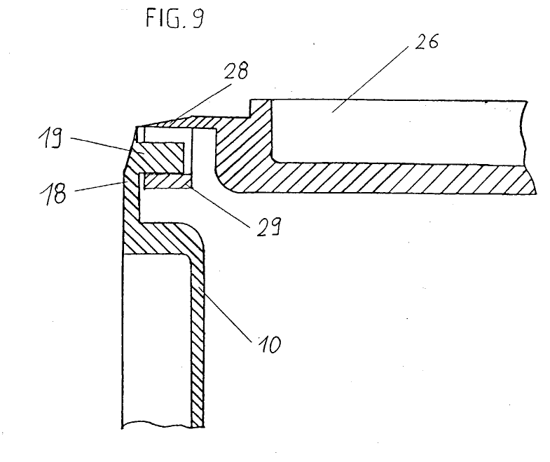

In order to make possible a reliable manipulation of the opened pocket stamp, as can particularly be seen in FIG. 5, the detent elements as seen in FIGS. 8 and 9 are provided.

These are comprised of T-shaped detent pieces 19 provided in the area of the hinge half 18 of the upper part 10 and of lock noses 29 provided in the area of the hinge half 28 of the lower part 20 and spring biased sideways. In the stamp position the lock noses 29 and T-shaped lock piece engage, as can be seen particularly from the sectional representation according to FIG. 9. Since the detent nose 29 is spring loaded sideways as indicated by double arrows 30, a snapping-in of the lock piece 19 in the hook-shaped lock noses and thus a releasing of the lock pieces 19 out of the lock noses 29 is made possible in simple manner.

Reference Number List

10 Upper part

11 Grip bar

12 Lock piece

13 Lock nose

14 Lock

15 Lower lock surface

16 Ink pad

17 Surface

18 Hinge half

19 Lock piece

20 Lower part

21 Grip part

22 Lock piece

23 Lock nose

24 Lock

25 Lower cover

26 Stamp

27 Surface

28 Hinge half

29 Lock nose

30 Movement arrows

1. Pocket stamp, comprised of a container in which a stamp is provided and a lid mounted pivotably on the container, which in the closed position covers over the stamp face and in the open position serves as a handle, thereby characterized, that the container comprises a shell shaped lower part (20) and the lid comprises a shell shaped upper part (10) of a flat container and the lower part (20) and upper part (10) are pivotably connected with each other via a hinge element (28, 18) unitary therewith.

2. Pocket stamp according to claim 1, thereby characterized, that the upper and lower parts (20, 10) are connected with each other via a film hinge (28, 18) and are produced unitary therewith in an injection mold process.

3. Pocket stamp according to claim 1 or 2, thereby characterized, that the upper part (10) is pivotably by more than 180° relative to the lower part (20), preferably 270°, and that the upper and lower parts (10, 20) are lockable relative to each other in the pivoted position.

4. Pocket stamp according to claim 3, thereby characterized, that locking elements (19, 29) are provided on the upper and lower parts (10, 20) in the area of the hinge (18, 28), which engage with each other when the upper part (10) is in the pivoted position.

5. Pocket stamp according to claim 1, thereby characterized, that the upper and lower parts (10, 20) are provided with grip bars (11, 21) projecting sideways beyond the contour of the container.

6. Pocket stamp according to claim 5, thereby characterized, that the grip bars (11, 21) of the upper and lower parts (10, 20) are set off relative to each other by 90°.

7. Pocket stamp according to claim 6, thereby characterized, that one grip part (21) respectively is provided on the oppositely lying sides of the lower part (20), and a grip bar (11) is provided on the side of the upper part (10) running perpendicular thereto.

8. Pocket stamp according to claim 1, thereby characterized, that the upper and lower parts (10, 20) are lockable with each other.

9. Pocket stamp according to claim 8, thereby characterized, that on the sides of the upper and lower parts (10, 20) opposite to the hinge (18, 28) there are provided locks (14, 24) and detent noses (13, 23) adapted for engaging in each other.

10. Pocket stamp according to claim 9, thereby characterized, that locks (14, 24) and lock noses (13, 23) are provided in the area of the grip part (11) of the upper part (10) and are thereby covered over in the closed condition of the container.

11. Pocket stamp according to claim 1, thereby characterized, that the stamp (26) provided in the lower part (20) is comprised of a stamp ink impregnated material, preferably a micro-sponge material.

12. Pocket stamp according to claim 1, thereby characterized, that the stamp (26) seated in the lower part (20) is comprised of a rubber or rubber-like plastic material and in the upper part (10) an ink pad (16) is provided, which in the closed condition of the container lies flush against the upper surface of the stamp (26).

13. Pocket stamp according to claim 1, thereby characterized, that the outer surfaces (17, 27) of the upper and lower parts (10, 20) are planar and carry advertisements.
